(19) United States
(12) Patent Application Publication
(10) Pub. No.: US 2014/0108286 A1
(43) Pub. Date: Apr. 17, 2014

(54) Lightweight Privacy Protection Protocol, Methods, and Systems for RFID and Sensor Based Logistics Track and Trace Data Sharing over Business Subcontracting Relationships

(71) Applicant: Hong Kong R&D Centre for Logistics and Supply Chain Management Enabling Technologies, Hong Kong (HK)

(72) Inventor: Chi Hung Tong, Hong Kong (HK)

(73) Assignee: Hong Kong R&D Centre for Logistics and Supply Chain Management Enabling Technologies, Hong Kong (HK)

(21) Appl. No.: 14/109,962

(22) Filed: Dec. 18, 2013

Related U.S. Application Data
(62) Division of application No. 13/417,209, filed on Mar. 10, 2012.
(60) Provisional application No. 61/451,556, filed on Mar. 10, 2011.

(51) Int. Cl. G06Q 10/08

(52) U.S. Cl. CPC G06Q 10/0833
USPC 705/333

(57) ABSTRACT

Subcontracting is a common practice in logistics industry for delivering goods from a consigner to a consignee, meaning that a prime logistics service provider, e.g. a third-party logistics company, usually outsources its contracted logistics service from the consigner to specialized companies to execute individual logistics operations. In the present disclosure, a light-weight privacy protection mechanism is introduced for these enterprises with subcontracting relationships to share logistics track and trace data captured with Auto-ID systems equipped with RFID readers, sensors, or global positioning devices. The mechanism consists of a set of protocols designed for the involved stakeholders to register and cancel subcontracting relationship, to set up and clear outsourced logistics job, to upload, update and clear the job data, to track the job execution progress and trace the job execution history, and a method and system to implement these protocols.

### CLAIM FOR DOMESTIC PRIORITY

This application is a divisional application of U.S. patent application Ser. No. 13/417,209, filed Mar. 10, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to methods and systems of Auto-ID enabled logistics track and trace data management. More particularly, the invention related to protocols, method and system of privacy protection and security control for RFID and sensor based logistics track and trace data sharing between involved stakeholders with business subcontracting relationships.

### BACKGROUND

Subcontracting is a common practice in logistics industry for delivering goods from a consigner to a consignee, meaning that a prime logistics service provider, e.g. a third-party logistics company, usually outsources its contracted logistics service from the consigner to specialized companies to execute individual logistics operations, such as consolidation and deconsolidation, warehousing, cross-border ocean shipping, train and truck transportation.

Visibility and security are key concerns of the prime logistics enterprise and its subcontractors in sharing logistics track and trace data. Auto-ID technologies, e.g. Radio Frequency Identification (RFID) and sensor, are promising enabling technologies that allow automatic identification and trajectory capture of moving logistics objects, e.g. items, products, pallets and containers, which can greatly improve the visibility and efficiency of logistics and supply chain management operations. But, the adoption of Auto-ID technologies presents these companies with potential risks of disclosing sensitive and valuable business information to unauthorized invaders or business competitors. Dynamics of the subcontracting relationships also make it very difficult for the prime company and its subcontractors to share track and trace data in efficient ways using traditional static database administration model. Thus, flexible data sharing policies and reliable security control mechanisms have to be developed to facilitate the wider adoption of Auto-ID technologies in track and trace applications of logistics and supply chain management.

There are two levels of security control in deploying Auto-ID technologies in logistics track and trace applications: lower data communication level and higher data sharing level in the context of business relationship. In the following description, we just take RFID as an example, which can be easily extended to other Auto-ID technologies enabled applications. Low level security control mainly focuses on the authentication of RFID reader and tag, encryption and decryption of the message transmitted between reader and tag. The details of which are disclosed in the papers: An Juels, RFID Security and Privacy: A Research Survey, 2006 and Filippo Gandino et al., Tampering in RFID: A Survey on Risks and Defenses, 2010; the contents of both documents are incorporated herein by reference in their entirety. High level security control focuses on identity or role based data accessing and data sharing mechanisms, which are widely used in traditional database management applications.

A series of standards developed by industrial consortium EPCglobal, including “The EPCglobal Architecture Framework”, “EPC Information Services (EPCIS) Specification,” “The Application Level Events (ALE) Specification,” provide architectural and technical guidance on RFID data management including data capturing, filtering, storage, accessing and sharing in global supply chain track and trace applications. The standards assume RFID data is collected at different sites and stored in a network of distributed databases when items and products move between organizations. Track and trace data accessing and sharing are implemented through standardized query interfaces provided by each database. Though the recently published specification, titled “EPCglobal Certificate Profile Specification”, describes how security functions, such as authentication, access control, validation, and privacy protection of individuals and corporations, will be distributed across many of the roles/interfaces operating within the EPCglobal network, security is still a major issue not fully addressed in EPCglobal's standards to handle the complexities of global supply chain track and trace.

By leveraging EPCglobal standards, an integrated security control mechanism can be employed to handle the privacy protection and security issues in dynamic supply chain track and trace applications. The details of the EPCglobal standards are disclosed in the paper: W. He et al., A Secure RFID-based Track and Trace Solution in Supply Chains, 2008; the content of which is incorporated herein by reference in its entirety. The mechanism integrates lower level tag-reader security scheme for RFID data capturing and updating and higher level Circle-of-Trust model (COT) for sharing track and trace data. To apply this mechanism in the track and trace application of enterprises with complex and dynamic subcontracting business relationships, a distributed network like EPCglobal network has to be established and a COT model has to be developed, which is not practicable in current logistics operations, especially for small and medium sized logistics enterprises.

A generic traceability data model and an innovative combination of query processing and data sharing techniques from P2P networks, distributed and parallel databases are presented in the paper: Rakesh Agrawal et al., Towards Traceability across Sovereign, Distributed RFID Databases, 2006, and in the U.S. Utility Patent Application titled: Middleware for Query Processing across a Network of RFID Databases (Rakesh Agrawal et al., U.S. Patent Application Publication No. 2008/0129452 A1); the contents of both documents are incorporated herein by reference in their entirety. The model and the techniques enhance the security of track and trace data sharing throughout the supply chain in the sense that: 1) each involved stakeholder is given complete sovereignty over its own data including business relationships information; 2) incoming query is executed and rewritten based upon pre-designed data sharing policies, which can be installed and modified without interaction with other parties.

Another access control model is proposed for monitoring mobile physical objects in logistics and supply chain, which allows users to implement security control and data sharing measures based on pre-set trajectory visibility policies. Referring to the paper: Florian Kerschbaum, An Access Control Model for Mobile Physical Objects, 2010; the content of which is incorporated herein by reference in its entirety. Being well-suited for distributed RFID systems, this model is an extension to attribute-based access control model, which originally aims to enable dynamic and fine-grained data sharing in service oriented environment. Referring to the paper: Eric Yuan et al., Attributed Based Access Control for Web Services, 2005; the content of which is incorporated herein by its entirety.

For central RFID data management solution, an RFID cube is introduced to support warehousing and analysis of massive RFID data sets. The details are disclosed in the paper: Hector Gonzalez et al., Warehousing and Analyzing Massive RFID Data Sets, 2006; the content of which is incorporated herein by reference in its entirety. The Oracle Corporation presented a new bitmap data type for Oracle DBMS to support RFID-based item tracking applications. Referring to the paper: Ying Hu et al., Supporting RFID-based Item Tracking Applications in Oracle DBMS Using a Bitmap Datatype, 2005; the content of which is incorporated herein by reference in its entirety. Both solutions assume that RFID data is collected and updated from separate users, and is stored within a single data repository.

To tackle the efficiency issues arising from incremental real-time RFID data update and analytical ad-hoc querying of central RFID data management solution, a single database approach is introduced, which merges OLAP (On-Line Analysis Processing) and OLTP (On-line Transaction Processing) components in only one central database system. Referring to the paper: Veneta Doreva et al., Put All Eggs in One Basket: An OLTP and OLAP Database Approach for Traceability Data, 2010. Security and confidentiality of RFID data are not fully addressed in all of these central management solutions once it is collected and uploaded into the central data repository.

In spite of the prior arts described above on RFID data management, security control and data sharing mechanisms, there remains a great need of efficient and lightweight methods for the prime logistics enterprise and its subcontractors to share logistics track and trace data over dynamic business subcontracting relationships.

### SUMMARY

It is an objective of the presently claimed invention to provide methods and systems of Auto-ID enabled logistics track and trace data management. It is a further objective of the presently claimed invention to provide a light-weight mechanism comprising protocols, a method and a system of privacy protection and security control for RFID and sensor based logistics track and trace data sharing between involved stakeholders with business subcontracting relationships.

It is a further objective of the presently claimed invention to provide a protocol for a prime logistics enterprise to register and de-register subcontracting relationship with its subcontractors; a protocol for the prime logistics enterprise to set up and clear outsourced logistics jobs; a protocol for subcontractors to update, upload and clear the outsourced jobs related data; a protocol for stakeholders to track outsourced jobs execution progress and trace job execution history based on business subcontracting relationships; and a protocol for public users to query traceability report of items and products with product code.

In accordance to various embodiments of the presently claimed invention, the methods comprise the steps and processes for the prime logistics enterprise and its subcontractors to upload and share track and trace data by utilizing the described protocols. In accordance to various embodiments of the presently claimed invention, the systems include at least a data repository to manage the static information on the involved enterprises and their subcontract relationships, a data repository to maintain the dynamic updates of track and trace data, and processing engines for handling transactional and analytical queries from end users.

In accordance to various embodiments of the presently claimed invention, the systems include a track and trace service platform with lightweight privacy control mechanism. The platform provides small and medium enterprises with an Auto-ID enabled affordable and secure solution to logistics track and trace applications, which integrates both the lower level data security control mechanism and higher level business subcontract relationship based data sharing strategies.

### BRIEF DESCRIPTION OF THE DRAWINGS

Embodiments of the invention, including artifacts for implementing the aforementioned protocols, methods, and systems, major user cases sequence diagrams and system architecture schematics are described in more detail hereinafter with reference to the drawings, in which:

FIG. 1 is an illustrative diagram showing the architecture of track and trace data management platform in accordance with embodiments of the present invention;

FIG. 2 is an illustrative diagram showing the physical goods flow and logistics operations of a cross-border logistics scenario;

FIG. 3 is an illustrative diagram showing one type of hierarchical subcontracting relationships of logistics service providers involved in the logistics scenario shown in FIG. 2;

FIG. 4 is a diagram showing one embodiment of the method of capturing and processing real time logistics operation data using Auto-ID enabled systems with privacy control mechanism in an embodiment of the present invention;

FIG. 5 is a diagram showing the interactions between logistics service providers with subcontracting relationships and a system implementing various embodiments of the present invention;

FIG. 6 is a diagram showing major user cases corresponding to a set of protocols in an embodiment of the present invention, and a method and a system in another embodiment of the present invention;

FIG. 7 is a diagram illustrating the message flows between users (prime enterprise, subcontractors, and the public), track and trace service platform, enterprise application systems, and data capturing systems equipped with Auto-ID devices, corresponding to user cases shown in FIG. 6; and

FIG. 8 is a flowchart showing major steps for implementing the protocols described in FIG. 6 in a logistics track and trace platform.

### DETAILED DESCRIPTION

In the following description, protocols of lightweight privacy protection, methods, and systems for RFID and sensor based logistics track and trace data sharing over business subcontracting relations are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The presently claimed invention discloses a lightweight privacy protection mechanism for logistics enterprises with subcontracting relationships to securely share and efficient query logistics track and trace data collected with Auto-ID enabled systems. The mechanism comprises a set of protocols for data security control and data sharing, a method and system to implement the protocols. Different embodiments of the invention will be described below in detail with reference to the drawings so that those skilled in the art can practice and implement the invention fully or partially.

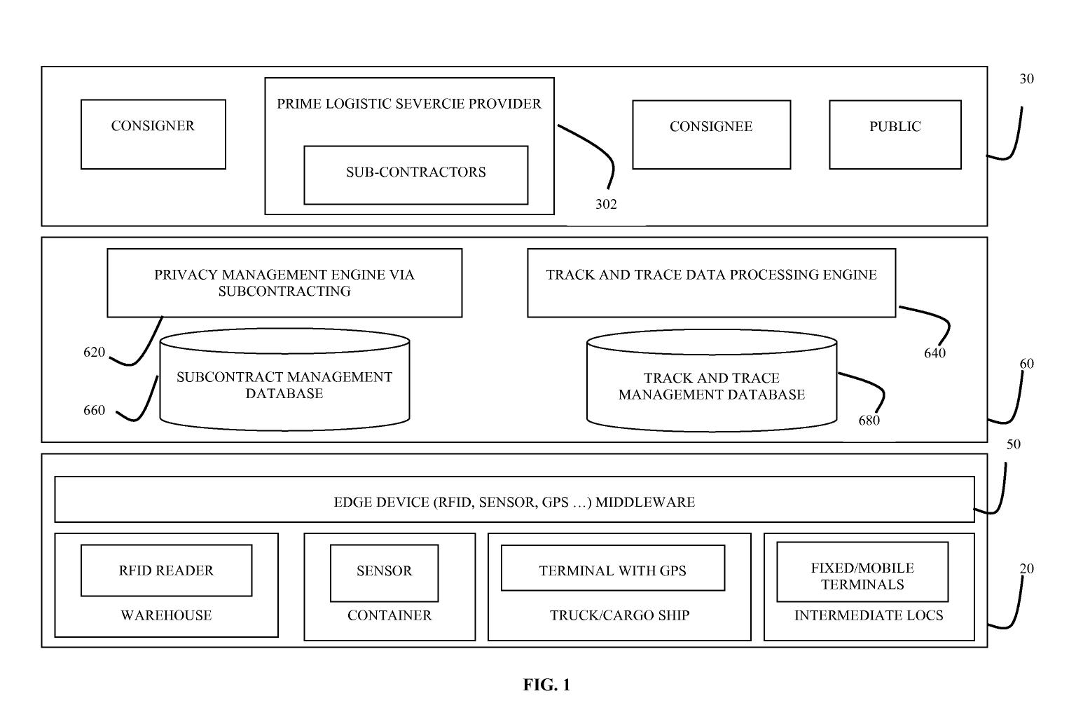

FIG. 1 illustrates one embodiment of the presently claimed invention, a logistics track and trace data management platform in accordance with other embodiments. The system can be implemented in multi-layer architecture, comprising the lowest level Auto-ID enabled data capturing systems 20, edge device middleware 50 for managing Auto-ID devices and processing primitive Auto-ID data, subcontracting relationship based track and trace management system 60 and the highest level user interfaces. End-users 30 of the system may include consigner and consignee, logistics services providers with subcontracting relationship 302 and public users. The subcontracting relationship based track and trace management system 60 primarily comprises data repository for subcontract management 660, track and trace data management database 680, privacy management engine 620, track and trace data and query processing engine 640.

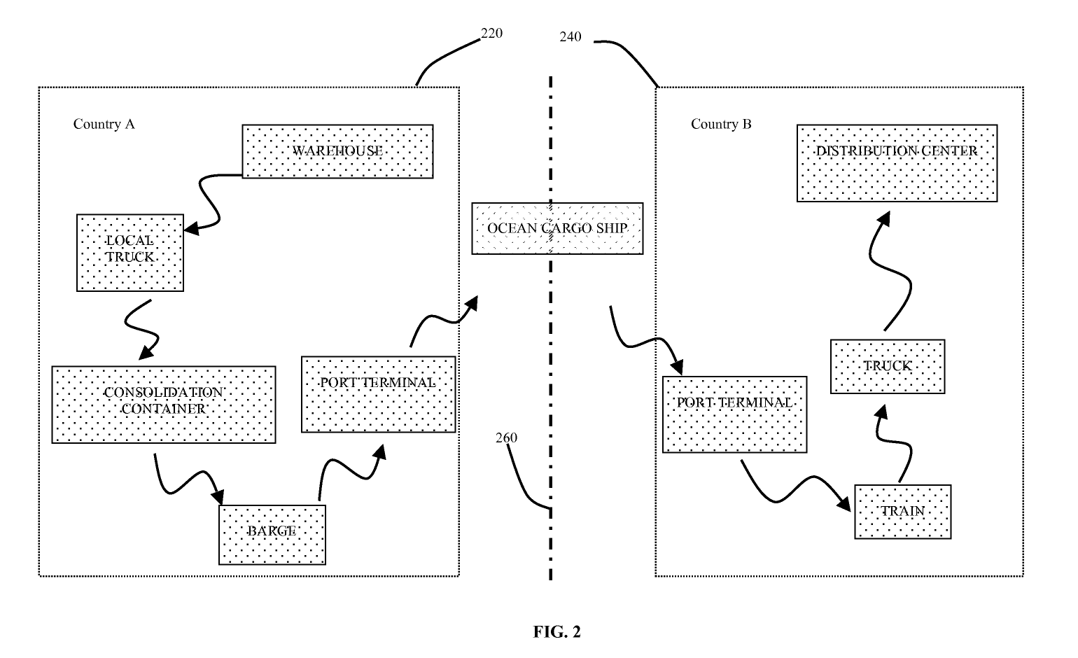

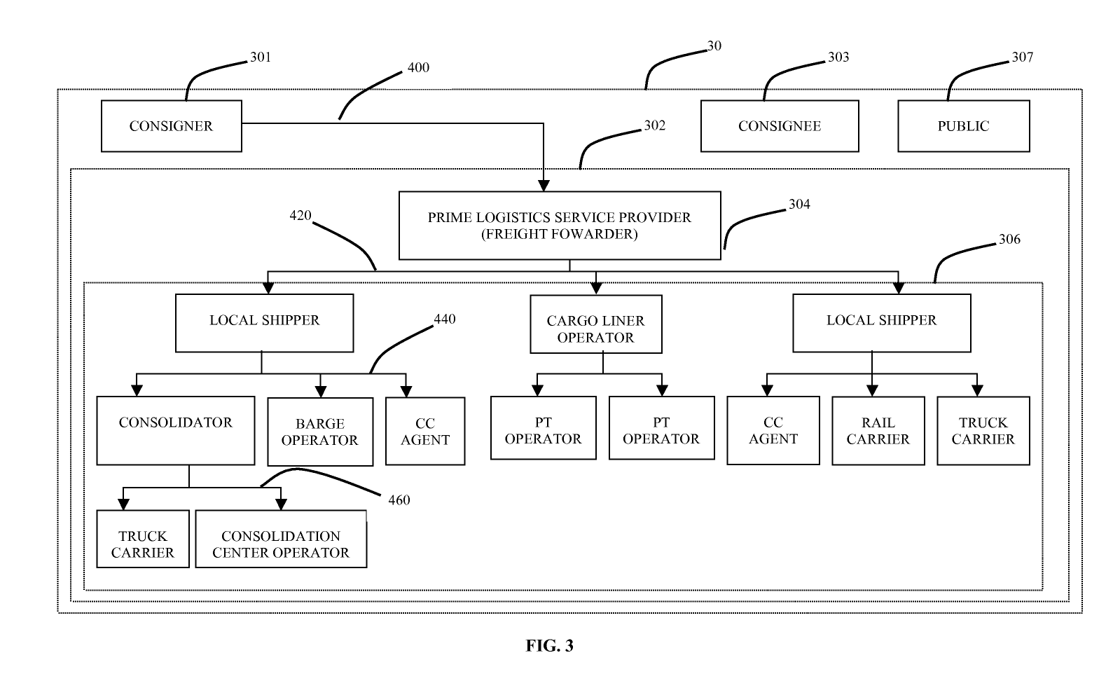

A typical cross-border logistics scenario is demonstrated in FIG. 2 to show the complexities of logistics operations of shipping goods from a consigner to a consignee. The operations are conducted in two countries: A 220 and B 240, involving various service providers and logistics operators (refer to FIG. 3). In country A, goods are shipped from the consignee's warehouse to consolidation centre via truck, followed by container transportation via barge to port terminal. In country B, goods are shipped from port terminal to the consignee's distribution centre in multi-transportation mode (e.g. train and truck). Ocean cargo ship is used for the cross-border 260 transportation from country A's port to country B's port.

As illustrated in FIG. 3, stakeholders involved in the scenario shown in FIG. 2 mainly include a consigner 301, logistics service provider and operators 302, a consignee and the public user 307. The consigner usually signs an outsourcing contract 400 with a third party logistics provider (a freight forwarder) 304 for delivering goods to its customers (the consignee). The logistics third party logistics provider 304 then subcontracts 420 individual logistics jobs to specific logistics operators, e.g. local shipper and cargo liner operator. The local shipper can further subcontract 440 its jobs to consolidator, barge operator and customs declaration and clearance agent. These jobs can be subcontracted 460 again to truck carrier and consolidation centre operator by the consolidator. So, hierarchical or networked subcontracting business relationships 306 are established between these involved logistics service provider and logistics operators. At each operation site of the involved participants, Auto-ID enabled systems and devices are deployed to sense goods ambient data and capture goods movement data.

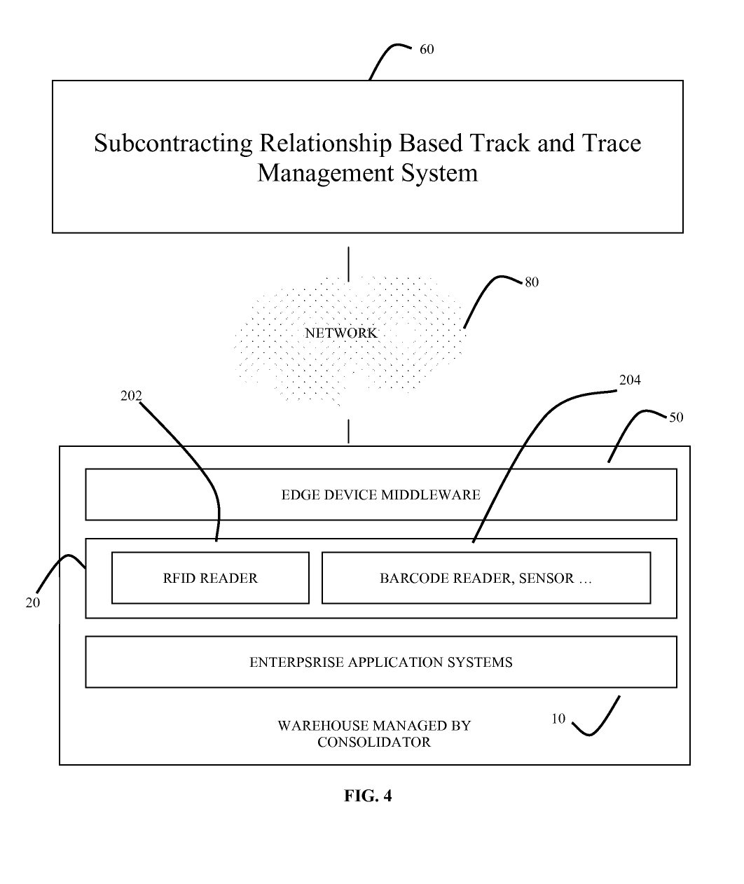

FIG. 4 shows the method of capturing real-time logistics trace and trace data using Auto-ID enabled systems with privacy control mechanism. At the source point of goods to be delivered, e.g. factory or exporter's warehouse, RFID tag, sensor or bar code carrying product code information (e.g. Electronic Product Code) may be attached to individual items, product boxes, or logistics equipments, e.g. pallets and containers. When the goods are in transit or pass through each logistics operation site equipped with Auto-ID enabled readers 20, their location information are recorded by scanning the attached tags or barcodes, and their ambient information (e.g. humidity and temperature) are captured by the deployed sensors. Auto-ID enabled readers 20 include, but not limited to, RFID reader 202, barcode reader and senor 204, etc. Business information related to the item and product being scanned may need to be storied in and retrieved from enterprise applications 10. Various types of edge device middleware may be utilized for managing the Auto-ID devices, transforming the raw tag reads into meaningful event and business object data, signing and encrypting the data, and uploading the encrypted data into central track and trace data repository through internet or virtual private network 80.

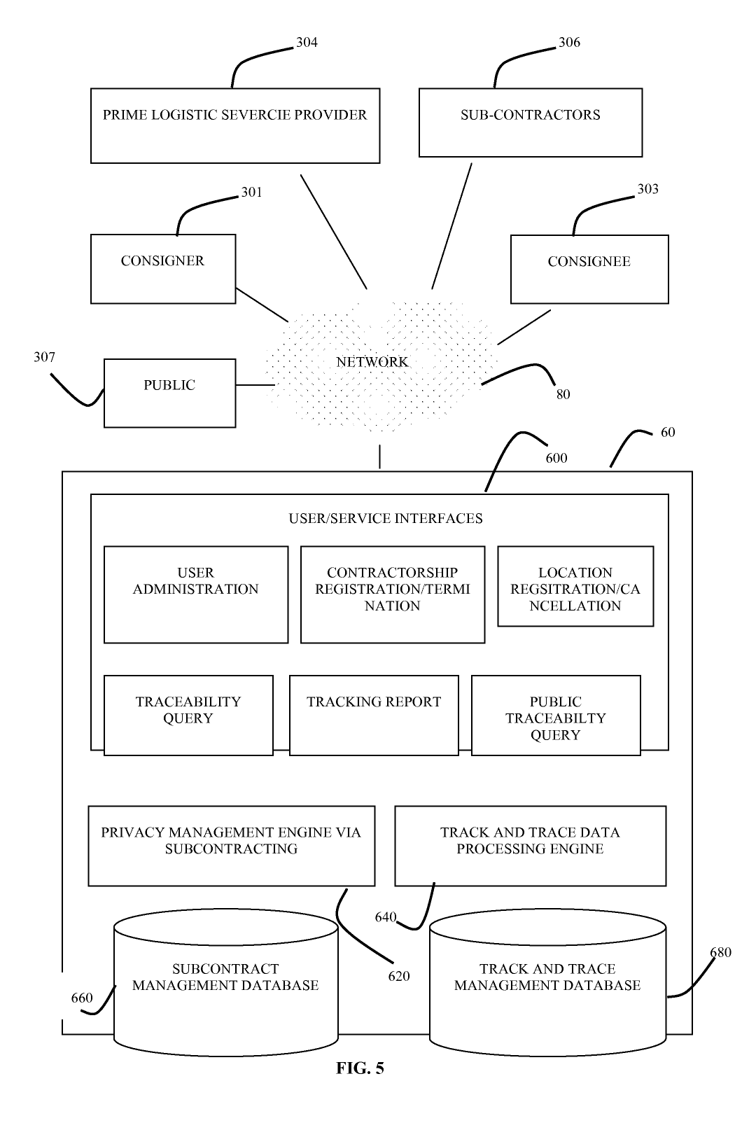

As shown in FIG. 5, in one embodiment of current invention, a logistics track and trace system may provide different involved stakeholders, including but not limited to consigner 301, consignee 303, prime logistics service provider 304, sub-contractors 306, with privacy control and data sharing functions based on business subcontracting relationships through such user interfaces or application service interfaces 600 as: user administration, contract relationship registration and de-registration, location registration and cancellation, traceability query, tracking report and public traceability query. End-users can access the user interfaces with popular web browsers or invoke service interfaces with standard web service protocols through internet or virtual private network 80.

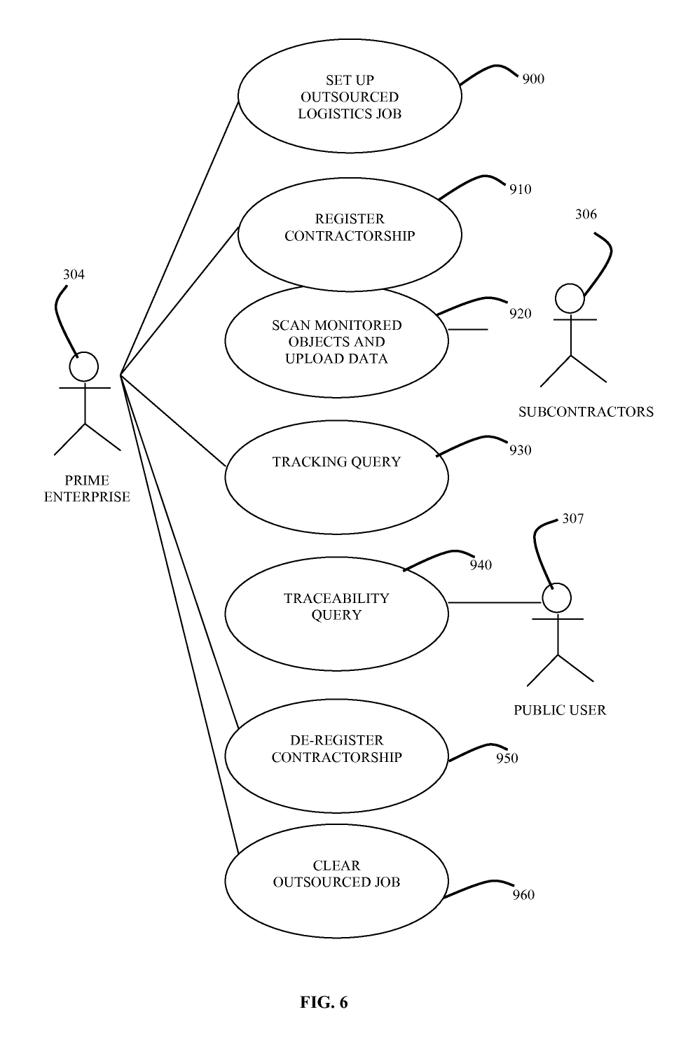

FIG. 6 illustrates major user cases corresponding to embodiments of the presently claimed invention: 1) prime enterprise 304 sets up job information to be outsourced to its subcontractors 900; 2) prime enterprise 304 registers contracting relationship with its subcontractors 910; 3) subcontractors 306 scan moving logistics objects, equipments, items and products equipped with RFID tags or sensors and upload encrypted monitoring data 920; 4) prime enterprise 304 queries the execution progress of specified logistics job 930; 5) public users 307 query the traceability information of the products they consume 940; 6) prime enterprise 304 de-registers contracting relationships with subcontractors 950; 7) prime enterprise 304 clears outsourced jobs' information 960.

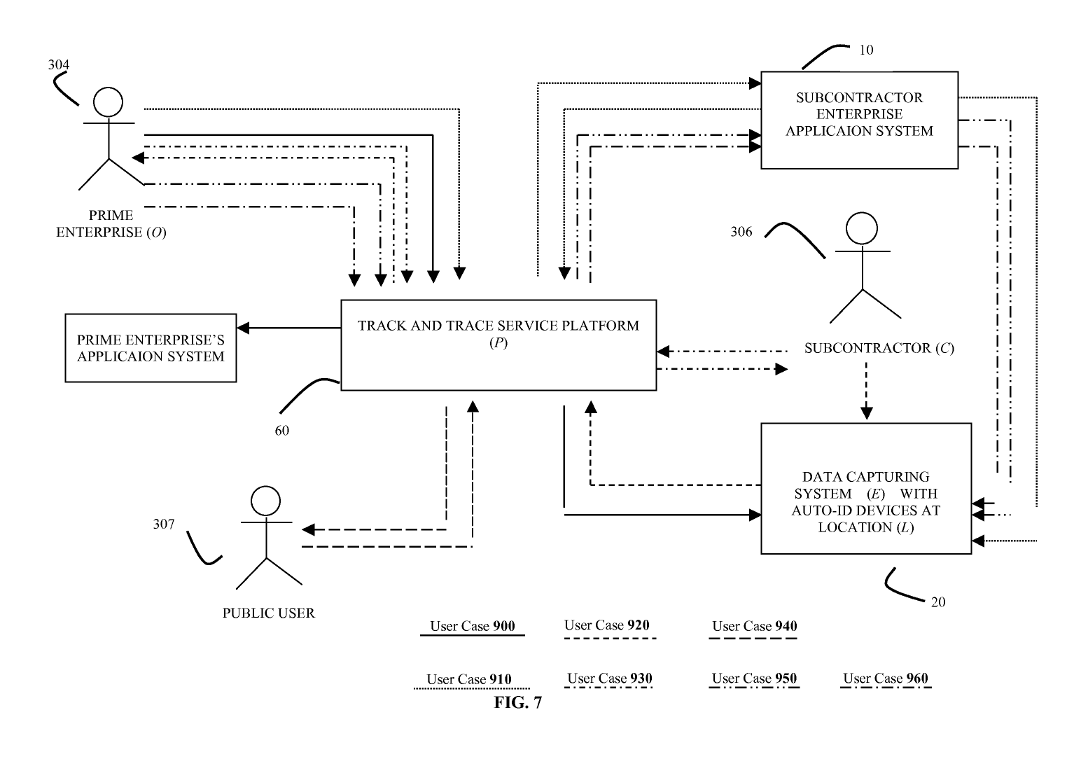

FIG. 7 describes the protocols which users and systems involved in the user cases described in FIG. 6 use to process and transit messages for uploading, accessing and sharing logistics track and trace data over subcontracting relationship. In the following descriptions, the prime enterprise 304 is denoted as data owner O, its subcontractors 306 as C, jobs outsourced by O to C as J, items identification related to J as ID, location where Auto-ID devices are deployed as L, track and trace controlling points as X, track and trace service platform as P, data capturing system with Auto-ID devices installed at location L as E.

The prime enterprise 304 needs to initialize and set up job information for outsourcing it to subcontractors (see solid lines in FIG. 7). The job information includes the job related item and product IDs, Auto-ID devices locations, track and trace control points etc. First, O sends job and control points' information to P, job and control points' information and item IDs to data capturing system E at Location L. Then, P stores job and control points information into its central data repository 660.

As shown in FIG. 7 in dotted lines, to register a subcontractor to complete a specified job, the prime enterprise 304 first needs to send to P its own identity information, its subcontractor's identity information, and the subcontracted job-item ID pairs, store these information into P's static data repository 660 and notify the subcontractor C 306 to set up job.

Data capturing system E can upload captured data into P over secure communication protocols (see dashed lines in FIG. 7). When items and products pass through C's logistics site L, C scans tags attached on these objects to get ID and logistics information written into the tags with fixed or handheld Auto-ID readers. Then, E digitally signs and encrypts the captured data, and sends the signed and encrypted data to P. In the end, P decrypts and verifies the received data, and stores the decrypted data into its dynamic data repository 680.

The prime enterprise and its subcontractors can track the outsourced job's execution progress or trace back its execution history by enquiring P with user identity information and job identity information (see dash-dotted lines in FIG. 7). P will return the query results in standard report templates.

Public users and supervision organizations can obtain traceability report of specified items and products by querying P with identification code, such as Electronic Product Code (see long dashed lines in FIG. 7). P will return the query results in standard report templates.

As illustrated in FIG. 7 in long-dash-dot-dotted lines, to de-register subcontracting relationship with its subcontractor, the prime enterprise needs to request P to delete the related job-contractor pairs by providing P with its identity information and the specified job information. Besides, P needs to update job location and control point information, and to notify C to delete the related job information. E needs to delete the related job-item ID pairs.

The prime enterprise 304 can request the track and trace service platform P to clear a specified job data by sending to P its user identity information and the information of the job to be cleared (see long dash-dotted lines in FIG. 7). Upon receiving clearing request, P will delete the dynamic data related to the job from its repository 680 and notify C to clear the related job data. C will notify data capturing system E to delete the related job-item ID pairs.

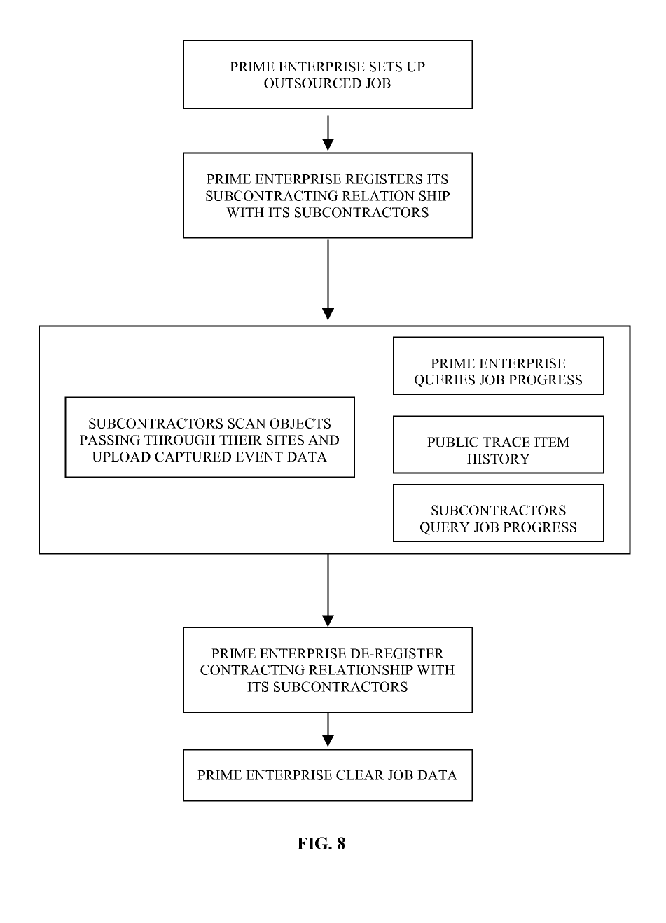

FIG. 8 describes the schematic flowchart and major steps on how to implement the protocols described in FIG. 6 and FIG. 7 in a logistics track and trace platform/system: 1) prime enterprise sets up outsourced job information. Once the information have been initialized and stored successfully in the static repository of the logistics track and trace platform/system, 2) the prime enterprise registers its subcontracting relationship with its subcontractors; 3) the subcontractors can start scanning objects passing through their sites and upload captured event data into the central dynamic data repository. In the mean time, 4) the prime enterprise, subcontractors, and public users can query the execution progress of the outsourced job or trace the logistics history of a specified product/item. For terminating subcontracting relationship with its subcontractors, 5) the prime enterprise needs to de-register contracting information in the track and trace platform. After the outsourced job is completed, 6) the prime enterprise can clear the job data in the logistics track and trace platform and its own enterprise application system.

In some embodiments, the present invention includes a computer storage medium having computer instructions or software codes stored therein which can be used to program a computer or microprocessor to perform any of the processes of the presently claimed invention. The storage medium can include, but is not limited to, floppy disks, optical discs, Blu-ray Disc, DVD, CD-ROMs, and magneto-optical disks, ROMs, RAMs, flash memory devices, or any type of media or device suitable for storing instructions, codes, and/or data.

The foregoing description of the presently claimed invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the presently claimed invention and its practical application, thereby enabling others skilled in the art to understand the invention for various embodiments and with various modifications that are suited to the particular use contemplated. It is intended that the scope of the presently claimed invention be defined by the following claims and their equivalence.

What is claimed is:

1. A track and trace system for management of subcontracting relationships by a first user comprising:
a storage means comprising a static data repository and a dynamic data repository;
a communication means for sending and receiving information to a plurality of users; and
a processing means for accessing the storage means and processing information to be sent and received using the communications means;
wherein the track and trace system is configured to:
receive a first information from the first user for initializing an outsourcing task to be performed by a second user;
send to a data capturing system, a plurality of job IDs obtained from the first information;
receive a second information from the first user for identifying the first user, the second user and the plurality of job IDs associated with the second user;
send to the second user, a notification to perform a portion of the outsourcing task upon receipt by the track and trace system of the second information, wherein the notification includes the plurality of job IDs associated with the second user;
receive from the data capturing system, a captured data obtained by the data capturing system by reading one of the plurality of job IDs, wherein the captured data is encrypted by the data capturing system;
decrypt the captured data and verify the captured data for association with the second user, and store said decrypted captured data in association with the second information;
receive from either the first user or the second user, a request to track the execution progress of the outsourcing task, wherein the request includes the information for identifying said first or second user; and
send a request result to said first user or second user, wherein the request result includes the decrypted captured data associated with said first user or second user.

2. The track and trace system according to claim 1, wherein the track and trace system is further configured to:
receive from a plurality of third users, a query including product information; and
send to the plurality of third users, a query result based on the captured data relating to the product information and further based on a permission information obtained from the first information.

3. The track and trace system according to claim 1, wherein the track and trace system is further configured to:
upon receipt of a control information containing information identifying the first user, compare said information identifying the first user with the second information stored in the storage means; and
process the control information to update the first and second information.

4. The track and trace system according to claim 3, wherein the processing of the control information comprises de-registering the subcontracting relationship with the second user, updating job location and control point information, or notifying the data capturing system to delete job information.

5. The track and trace system according to claim 1, wherein the communication means includes both a secure communication protocol and an unsecure communication protocol.

6. The track and trace system according to claim 1, wherein the first information received from the first user comprises job information and control points information.

7. The track and trace system according to claim 1, wherein the second information is stored in the static data repository.

8. The track and trace system according to claim 1, wherein the captured data is stored in the dynamic data repository after decryption.

9. The track and trace system according to claim 1, wherein the request comprises job information.

10. The track and trace system according to claim 1, wherein the request result is provided using a standard report template.

11. The track and trace system according to claim 2, wherein the query result is provided using a standard report template.

12. The track and trace system according to claim 1, wherein the first user is one of a consigner, consignee, logistics service provider or sub-contractor.

13. A track and trace method for management of subcontracting relationships by a first user comprising:
storing a static data repository and a dynamic data repository;
sending and receiving information to a plurality of users; and
accessing the stored static data repository and dynamic data repository, and processing information to be sent and received using the communications means;
wherein the track and trace method is further comprising:
receiving a first information from the first user for initializing an outsourcing task to be performed by a second user;
sending to a data capturing system, a plurality of job IDs obtained from the first information;
receiving a second information from the first user for identifying the first user, the second user and the plurality of job IDs associated with the second user;
sending to the second user, a notification to perform a portion of the outsourcing task upon receipt by the track and trace system of the second information, wherein the notification includes the plurality of job IDs associated with the second user;
receiving from the data capturing system, a captured data obtained by the data capturing system by reading one of the plurality of job IDs, wherein the captured data is encrypted by the data capturing system;
decrypting the captured data and verifying the captured data for association with the second user, and storing said decrypted captured data in association with the second information;
receiving from either the first user or the second user, a request to track the execution progress of the outsourcing task, wherein the request includes the information for identifying said first or second user; and
sending a request result to said first user or second user, wherein the request result includes the decrypted captured data associated with said first user or second user.

14. The track and trace method according to claim 13, wherein the track and trace method is further comprising:
receiving from a plurality of third users, a query including product information; and
sending to the plurality of third users, a query result based on the captured data relating to the product information and further based on a permission information obtained from the first information.

15. The track and trace method according to claim 13, wherein the track and trace method is further comprising:
upon receipt of a control information containing information identifying the first user, comparing said information identifying the first user with the second information stored in the storage means; and
processing the control information to update the first and second information.

16. The track and trace method according to claim 15, wherein processing the control information comprises de-registering the subcontracting relationship with the second user, updating job location and control point information, or notifying the data capturing system to delete job information.

17. The track and trace method according to claim 13, wherein sending and receiving information to a plurality of users includes both a secure communication protocol and an unsecure communication protocol.

18. The track and trace method according to claim 13, wherein the first information received from the first user comprises job information and control points information.

19. The track and trace method according to claim 13, wherein the second information is stored in the static data repository.

20. The track and trace method according to claim 13, wherein the captured data is stored in the dynamic data repository after decryption.
